(19) United States
(12) Patent Application Publication
(10) Pub. No.: US 2012/0066044 A1
(43) Pub. Date: Mar. 15, 2012

(54) STORED VALUE ELECTRONIC CERTIFICATE PROCESSING

(75) Inventors: William L. Honnef, Camarillo, CA (US); Donald L. Endres, Brookings, SD (US)

(73) Assignee: CyberSource Corporation, Mountain View, CA (US)

(21) Appl. No.: 13/243,972

(22) Filed: Sep. 23, 2011

Related U.S. Application Data
(63) Continuation of application No. 09/914,287, filed on Aug. 23, 2001.
(60) Provisional application No. 60/121,956, filed on Feb. 25, 1999.

(51) Int. Cl. G06Q 30/06; G06Q 30/02

(52) U.S. Cl. 705/14.23; 705/26.1

(57) ABSTRACT

An electronic stored value certificate processing system is provided in which a certificate processor (112) issues stored value certificates to consumers in association with an online merchant (108), and redeems the certificates to a receiver as value received for products or services of the merchant. The certificate processor issues a graphical virtual stored value certificate in the name of the merchant. The stored value gift certificate processor interacts logically and exclusively with the merchant, and the merchant controls interaction with the consumer. Using a Promotions Certificate, merchants can send a file of consumer email address and the amount or value of each certificate to the stored value gift processor. The stored value gift processor creates, loads, and issues the Promotions Certificates using email. A consumer receiving a Promotions Certificate can use it at the merchant's online store in exchange for goods and services.

### CROSS-REFERENCES TO RELATED APPLICATIONS

This application is a continuation patent application of pending U.S. patent application Ser. No. 09/914,287, filed Aug. 23, 2001 which is a National Stage Entry of International Application No. PCT/US00/05039, filed Feb. 25, 2000, which claims domestic priority from prior U.S. provisional patent application Ser. No. 60/121,956, filed Feb. 25, 1999, entitled Stored Value Certificate System, by named inventors William L. Honnef and Donald L. Endres, the entire contents of which are hereby incorporated by reference as if fully set forth herein.

### FIELD OF THE INVENTION

The present invention generally relates to data processing. The invention relates more specifically to methods, apparatus, systems and products that provide electronic stored value certificates.

### BACKGROUND OF THE INVENTION

Electronic commerce systems, in which buyers can order and pay for products online, have gained wide use throughout the world. Some electronic commerce systems may be used to process transactions with individual consumers, and others may be used to carry out transactions between business, known as business-to-business electronic commerce.

The electronic commerce systems that interact with consumers generally collect online orders submitted by the individual consumer over a public data network. Normally, a consumer who wishes to order a product fills out and submits an online form, or answers a series of prompts from the electronic commerce system. The electronic commerce system sends the order information to a merchant that fulfills the order. Such electronic commerce systems are now widely used in connection with the global, packet-switched network of internetworks known as the Internet, and its system of browsers and servers known as the World Wide Web.

In consumer-to-consumer commerce involving traditional, brick-and-mortar retail stores, gift certificates are widely used to transfer value. In this approach, a first consumer (the gift certificate giver) contacts a retail store or catalog that is associated with a merchant. The first consumer requests a gift certificate of a particular amount, and transfers funds to the merchant in an amount equal to the face value of the gift certificate. In some cases, the merchant requests and receives the name and identifying information of a second consumer (the gift certificate receiver). The merchant delivers the gift certificate in paper form to the first consumer, who delivers it to the second consumer. Alternatively, the merchant may deliver the certificate to the second consumer. At some point after delivery, the second consumer contacts the merchant, selects merchandise offered by the merchant, and tenders the gift certificate as payment for the merchandise. Sometimes the gift certificate receiver selects merchandise having a cost greater than the face value of the gift certificate, in which case the receiver also tenders additional funds to cover the difference in value.

Although this approach is familiar to consumers, it has significant disadvantages. Further, gift certificates are not readily available in electronic commerce for a variety of reasons.

First, for an online merchant to implement an electronic gift certificate mechanism, generally the online merchant is required to construct supporting software and hardware infrastructure itself, or contract for its development. This requires significant resources and time to implement. Online merchants would greatly benefit from an ability to add electronic gift certificate capability to their online stores or sites without incurring development costs and delays.

Second, gift givers purchase gift certificates in part to give the recipient more control over the selection of a gift. However, traditional gift certificates are merchant specific, that is, they can be redeemed only at the merchant who sold the certificate. Consumers prefer certificates that are redeemable at multiple merchants and at both online stores and physical stores. An example of a traditional, paper-based gift certificate that is redeemable at a plurality of merchants is the American Express Gift Cheque. There is a need for an electronic gift certificate mechanism that permits an online gift receiver to redeem an electronic gift certificate at any of a plurality of online merchants.

A third drawback of known gift certificates is that they cannot be used as coupons or discount mechanisms. Presently, online merchants are investing significant resources to attract new customers to their online stores by offering promotions that include coupons and discounts. These two promotion mechanisms have limitations. For example, customers may receive many coupons and discount offers, and the use of coupons and discount offers tends to communicate the message that merchants' products are overpriced. Further, a consumer may use one promotional mechanism to visit an online merchant, but only a small percentage of such consumer visitors actually shop at the online merchant and purchase a product. A more compelling promotion tool is needed to attract new customers who actually shop at a merchant site and complete the purchase process.

Merchants are also interested in promotional mechanisms that have a fixed cost per new consumer. Some merchants also wish to run a promotion that allows a promotion certificate to be redeemed at a different merchant. For example, a publisher wanting to attract new consumers to their site may issue a certificate redeemable at multiple other merchant sites. As another example, a merchant may wish to issue a certificate that is redeemable at an affiliate merchant site. While various paper gift certificate approaches are available in traditional store and catalog promotions, there is a need for an online, electronic gift certificate approach that provides a certificate redeemable at single and multiple online merchant stores.

Another disadvantage of existing approaches is that once a merchant has a new consumer, the merchant needs tools to keep the customer coming back the merchant online store. Some merchants have joined universal loyalty programs in which the customer earns points redeemable for airline miles or other products or services not supplied by the merchant. A more attractive merchant program would involve rewarding a frequent shopper with a merchant's own products to reduce costs and to keep a closer relationship with the customer.

Currently there is no mechanism in which online merchants can deliver online, electronic loyalty certificates to frequent or valued customers. Further, there is a need for a loyalty certificate program that offers loyalty certificates redeemable for only a particular merchant's goods and services.

Merchants also are continually looking for ways to motivate employees with incentive programs that are tied to attaining specific goals. Although some companies have used paper-based gift certificates as an employee incentive, no method is currently available to electronically issue and redeem incentive certificates over a network for the purpose of rewarding employees. There is a need for such reward programs for the purpose of benefiting both employers and employees.

### BRIEF SUMMARY OF THE INVENTION

The foregoing needs and objects, and other needs and objects that will become apparent from the following description, are achieved by the present invention, which comprises, in one aspect, a certificate processing system in which a certificate processor handles all details relating to issuing, notifying and redeeming electronic virtual certificates. The certificate processor issues a graphical virtual certificate that looks and feels like it is actually the merchant's own certificate. At the merchant's option the processor also issues a paper representation of the virtual certificate. The certificate processor interacts logically and contractually exclusively with the merchant, and the merchant controls interaction with the consumer. The certificate processor tracks the outstanding value of the certificate. In one embodiment, the merchant holds the funds continuously from the time of purchase through redemption. Alternatively, a certificate redeemable at a particular merchant may be issued from a server or site not controlled or owned by that merchant; the party that owns or controls the server or site acts as issuer of the certificate, and holds funds in the form of stored value from the time of certificate purchase through redemption. A merchant administration application enables a merchant to manage certificate information.

The system includes a Promotions Certificate mechanism that enables merchants to mass issue electronic Promotions Certificates to attract customers to their online store. Using a Promotions Certificate, merchants can electronically send a file of consumer email addresses and the amount or value of each certificate to the stored value certificate processor. The stored value certificate processor creates, loads, and issues the Promotions Certificates, and notifies the recipient using electronic mail (email). A consumer receiving the Promotions Certificate can use it at the designated merchant online store in exchange for selected goods and services.

The system also includes a Loyalty Certificate that allows an online merchant to set up customer loyalty programs that result in awards of that merchant's goods or services. Each time a customer shops a particular online merchant site, the merchant credits a loyalty certificate based on a pre-determined fraction of the purchase total. The consumer can check the balance of the loyalty certificate at any time, and redeem it for other goods or services of the merchant.

In another embodiment, an Incentive Certificate is issued and delivered through a network and provides employers with a new tool to positively influence employee behavior and performance. An employer provides an electronic list of each employee who is a part of the employer's incentive certificate plan. When a particular employee achieves a particular goal, the employer adds value to the incentive certificate associated with that employee. The employer may add such value by connecting to the system and posting the appropriate value amount, or by periodically sending an electronic file to the system that contains value or “load” amounts for each certificate. An employee can check the balance of that employee's Incentive Certificate at any time and redeem it in exchange for goods and services selected at any participating merchant.

The invention also encompasses an apparatus, system, and computer-readable medium that may be configured to carry out the foregoing steps.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is a block diagram of a stored value certificate processing system.

FIG. 1B is a block diagram of a second stored value certificate processing system.

FIG. 2A is a block diagram of functional elements of a stored value certificate processing system that may interact with a stored value certificate processor and clients with which the processor may interact.

FIG. 2B is a block diagram of functions that may be carried out by a stored value certificate processor.

FIG. 3 is a flow diagram of a Purchase Certificate function.

FIG. 3A is a continuation of FIG. 3.

FIG. 3B is a flow diagram of Notification and Confirmation functions.

FIG. 3C is a flow diagram of a Redeem Certificate (single tender) function.

FIG. 3D is a continuation of FIG. 3C.

FIG. 3E is a diagram of an example of a certificate order form.

FIG. 4A is a flow diagram of a Certificate Administration (Recipient—View Certificate) function.

FIG. 4B is a flow diagram of a Certificate Administration (Purchaser-Notification Status) function.

FIG. 4C is a flow diagram of a Merchant Administration function.

FIG. 4D is a continuation of FIG. 4C.

FIG. 5A is a block diagram of a method of redeeming a stored value certificate that is redeemable only at one merchant or issuer.

FIG. 5B is a block diagram of a method of redeeming a stored value certificate that is redeemable at a plurality of merchants or issuers.

FIG. 6 is a block diagram of a computer system with which an embodiment may be implemented.

### DETAILED DESCRIPTION OF THE INVENTION

A method and apparatus providing stored value electronic certificate processing is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### Operational Context

### Network Structure

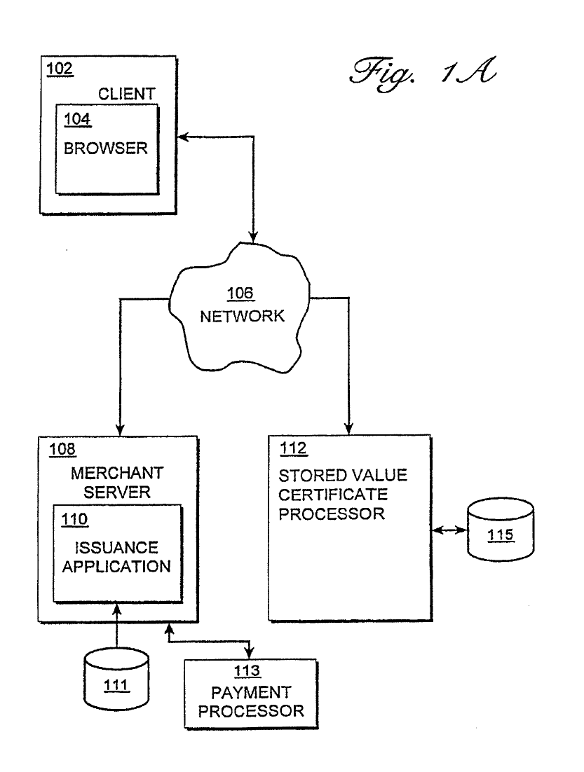

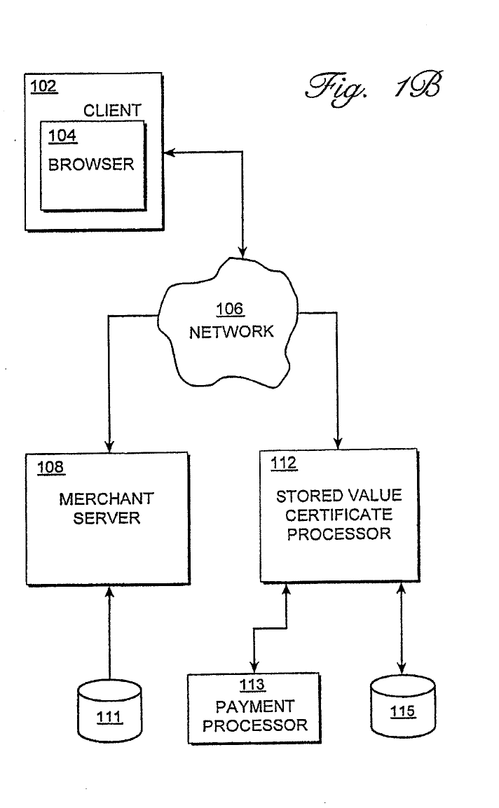

FIG. 1A is a block diagram of a stored value electronic certificate processing system that represents a context in which an embodiment may be practiced.

Client 102, which executes browser 104, is coupled logically to network 106. Client 102 is any network end station, such as a personal computer, workstation, or other device having a processor. Although one client 102 is shown in FIG. 1, in a practical system there may be any number of clients coupled to network 106.

Browser 104 is one or more software or hardware elements that cooperate to read and display electronic documents that are formatted according to open protocols. An example of a commercial product that may be used to implement browser 104 is Netscape Navigator®. Network 106 is a collection of one or more devices and interconnecting elements that support data communications using open protocols. In one embodiment, network 106 is a public, packet switched data network such as the Internet.

One or more merchant servers 108A, 108B, 108N, (do not see on diagram) etc., may execute a certificate issuance application 110 and also are logically coupled to network 106. Each merchant server 108 A, 108B, 108N is owned, operated, controlled by, or affiliated with one particular online merchant or certificate issuer. Merchant server 108 A, 108B, 108N is one or more hardware or software elements that provides a point of contact between a user of client 102 and a merchant that is in the business of selling one or more products or services. Merchant server 108 A, 108B, 108N may be located at the merchant's place of business, but this is not required. Normally merchant server 108 A, 108B, 108N is a secure commerce server suitable for use with the World Wide Web, and also includes an HTTP (Web) server. Microsoft® Internet Information Server is an example of a commercial product that is suitable for use as merchant server 108 A, 108B, 108N.

Issuance application 110 is one or more hardware or software elements that cooperate to carry out certificate issuance in cooperation with stored value certificate processor 112. Issuance application may include functions and routines that implement stored value certificate issuance, viewing, notification, redemption, and administration functions, as described further herein.

One or more separate merchant applications may be executed by merchant server 108A, 108B, 108N and may comprise one or more hardware or software elements that cooperate to offer products or services to the consumer, display information about the products or services, and solicit orders for the products or services. Such merchant applications generally provide a main commercial interface of the merchant to the consumer or user. The merchant applications may retrieve and store data about products, services, consumers, and orders in a database 111 that is logically coupled to the merchant server 108A, 108B, 108N and the Issuance application.

A payment processor 113 may be coupled to merchant server 108 A, etc. for the purpose of submitting payment transactions to credit card clearance networks, the automated clearinghouse network, wire transfer networks, etc. For example, payment processor 113 can receive a credit card number and other credit card information from merchant server 108A, etc., and can carry out a charge transaction through the credit card networks operated by Visa, Mastercard, American Express, and others. As a result, value is transferred from an account of a purchaser to an account associated with the owner or operator of merchant server 108.

Although the term “merchant” is used to identify merchant server 108, it may be owned, operated or controlled by a non-merchant issuer, such as a third party issuer, credit card company, trade association, merchants association, bank, credit union, governmental organization, etc.

Stored value certificate processor 112 is one or more hardware or software elements that service requests of merchants from clients to issue, notify, redeem, manage and report the status of one or more virtual electronic stored value certificates. It may be remote from merchant server 108 A, 108B, 108N or co-located with the merchant server. In the preferred embodiment, Stored value certificate processor 112 is remote from merchant server 108 A, 108B, 108N and communicates with the merchant server through network 106 using an agreed-upon protocol.

Alternatively, stored value certificate processor 112 comprises two servers running in parallel at separate locations maintain certificate balances and manage transactions. Two servers connected to a public network through different access mechanisms, e.g., Internet Service Providers, ensure connectivity in the case of a partial network failure.

The stored value certificate processor 112 may store and retrieve information using a relational database 115, which serves as a core repository of certificate information. The database 115 includes stored programs and procedures that manage certificate purchaser, recipient, and merchant information, as well as balance, transaction, settlement, and customer service information. Database 115 also contains a record for each certificate that contains all information pertaining to a certificate. In one embodiment, database 115 is a relational database system having a Certificate table that contains one or more fields for certificate information. The specific nature of the fields and their use is described further below.

FIG. 1B is a block diagram of an alternative stored value electronic certificate processing system that represents a context in which an embodiment may be practiced.

In the embodiment of FIG. 1B, merchant server 108 lacks an issuance application and payment processor 113 is coupled to stored value certificate processor 112. In this arrangement, certificate processor 112 acts as a host for certificate issuance functions. Thus, certificate processor 112 issues certificates on behalf of the merchant that is associated with merchant server 108. In particular, certificate processor 112 may host one or more servers, electronic documents, or Web sites that appear to be associated only with one of a plurality of merchants, through branding, page content, etc. In this configuration, certificate processor 112 carries out all certificate processing tasks so that merchants need not implement such functionality at their servers or sites. Clients may connect to merchant server 108, select a certificate issuance hyperlink, and be redirected to certificate processor 112 without awareness on the part of the client that it has left the domain of the merchant server. The client may then carry out certificate processing functions in the same overall transaction used for the client to order products or services from the merchant server 108.

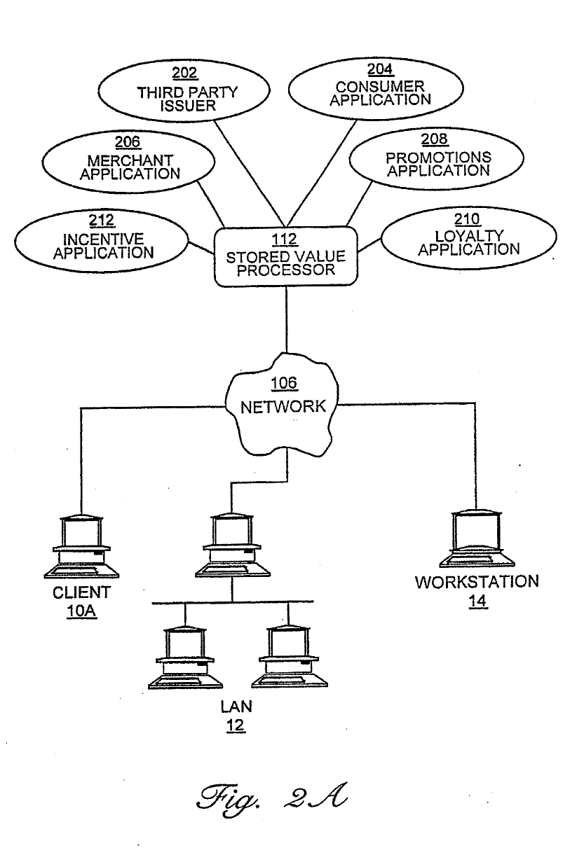

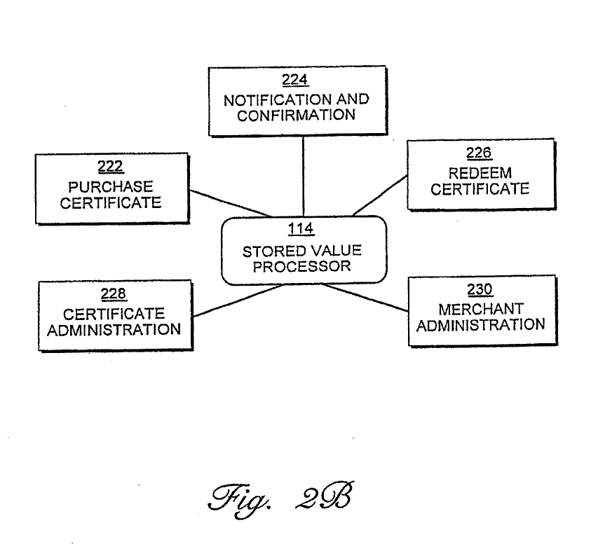

FIG. 2A is a block diagram of functional elements of a stored value certificate processing system that may interact with a stored value certificate processor.

In one embodiment, stored value certificate processor 112 interacts with a plurality of servers or Web sites that are associated with different roles and functions involved in stored value certificate processing. In one preferred embodiment, stored value certificate processor 112 interacts with third party issuer 202, consumer 204, merchant 206, promotions application 208, incentives application 212, and loyalty application 210. Each of the third party issuer 202, consumer 204, merchant 206, promotions application 208, incentives application 212, and loyalty application 210 may be implemented in the form of a Web server, or as a Web site that is executed by a separate server or collectively executed by a single server. This architecture separates and organizes Web pages, scripts, and other software elements by functional area and application type. Each of the third party issuer 202, consumer 204, merchant 206, promotions application 208, incentives application 212, and loyalty 210 links to the stored value certificate processor through one or more hyperlinks or script calls.

Stored value certificate processor 112 uses network 106, which may be the public Internet, and secure communication protocols to communicate with merchant servers and client browsers. As its clients, stored value certificate processor 112 may interact with an individual computer 10A, a local area network 12 comprising multiple client computers, a workstation 14, etc.

In one preferred embodiment, stored value certificate processor 112 comprises two parallel computer systems, each of which is logically connected to network 106 through a separate network service provider. This tends to ensure uninterrupted operation. If the primary system goes offline, the secondary system takes over all processing.

FIG. 2B is a block diagram of functions that may be carried out by a stored value certificate processor and clients with which the processor may interact. In one embodiment, stored value certificate processor can carry out a purchase certificate function 222, notification and confirmation functions 224, redeem certificate function 226, certificate administration functions 228, and merchant administration functions 230. Such functions are described further below.

### Communication Protocol

In one embodiment, merchant server 108A, 108B, 108N communicates with stored value certificate processor 112 using HTTP (Hypertext Transport Protocol) over a SSL (Secure Sockets Layer) connection. Messages are exchanged by performing one or more HTTP GET operations using name and value pairs as parameters. The name and value pairs are generated by client software residing on the merchant server 108. The merchant server returns a set of name and value pairs with the resulting page, that are transparently received and translated back to the client.

The APPENDIX to this document sets forth field names, function calls that use the field values, the format of the fields, and the amount of database storage used for each field, of fields that may be used in database 115 and in messages that use the foregoing communication protocol. Such fields may be used in messages between merchant server 108, or another server of a third party certificate issuer, to communicate with stored value certificate processor 112 and to carry out the functions described herein.

In an alternative embodiment, merchant server 108A, 108B, 108N communicates with stored value certificate processor 112 using Simple Commerce Messaging Protocol (SCMP), which is defined in the document http://search.ietf.org/internet-drafts/draft-arnold-scmp-01.txt. SCMP is an open standard that provides secure, authenticated commerce messaging capabilities between a sending agent's application to a receiving agent's server. The response by the receiving agent's server to the sending agent is a reply for the transaction represented by the set of data in the message. SCMP enables merchant server 108A, 108B, 108N and stored value certificate processor 112 to perform on-line business transactions such that the merchant is fully authenticated, and the message cannot be repudiated.

In the preferred embodiment, SCMP messages requesting the use of commerce application 112 are sent from the merchant server 108A, 108B, 108N to stored value certificate processor 112. Each message contains fields that describe the application request and provide necessary information about the consumer or end user, the merchant, and the stored value certificate. Preferably, SCMP messages are digitally signed and converted to ASCII format for transmission over a Hyper Text Transfer Protocol (HTTP) connection, enabling the messages to pass through firewalls and proxy servers.

Software elements that can send and receive SCMP messages are installed at or executed by merchant server 108 A, 108B, 108N and stored value certificate processor 112.

### Implementing Stored Value Certificate Processing

In one embodiment, stored value certificate processor 112 may be developed by creating one or more scripts that send SCMP messages requesting input from merchant server 108A, 108B, 108N. The scripts are written under Common Gateway Interface (CGI), Active Server Protocol (ASP), Internet Server Application Programming Interface (ISAPI), or Netscape Application Programming Interface (NSAPI) using pre-defined C/C++, Java, or Perl libraries. The libraries are commercially available from CyberSource Corporation.

Alternatively, the interface may be developed using object software such as CyberSource's Digital Commerce Component (DCC) that automates SCMP scripting. The DCC supports SCMP messaging and provides an interface to reduce development effort. An application developer may add appropriate scripts to interpret the results of a request for a customer.

### Message Communications and Formats

In operation, client 102 connects through network 106 to merchant server 108A, 108B, 108N. A consumer who is operating client 102 and browser 104 uses the browser to display one or more electronic documents stored at merchant server 108A, 108B, 108N including pages that display product and service information. One of the pages may relate to issuing or redeeming a virtual electronic stored value certificate. When a stored value certificate processing request is entered, merchant server 108 A, 108B, 108N exchanges one or more messages with stored value certificate processor 112 over network 106 to carry out order processing functions.

Each message provides stored value certificate processor 112 with information about the stored value certificate processing function that is being requested. The information may include: verification of the merchant as a legitimate merchant; identification of a function, such as purchasing a certificate, confirming delivery, redeeming a certificate, or administrative functions; or end user information required by the requested stored value certificate function.

In one embodiment, the messages use the SCMP protocol, and the messages are created using scripts in C/C++ or Perl that call library functions to send the messages. In another embodiment, an interface to a commerce-ready third-party server (“commerce ready platform”) is used, and the interface composes and sends the messages. Examples of commercially available commerce-ready third-party servers are Microsoft® Site Server 3.0, Commerce Edition; Microsoft® Active Server Pages; and BroadVision. One or more scripts are used to call the desired stored value certificate functions and interpret the results.

Within an SCMP message, separate fields specify information about (a) the particular stored value certificate function that the issuance application 110 is requesting from stored value certificate processor 112; (b) the value of the associated stored value certificate, if needed; and (c) the consumer who is placing the order. The stored value certificate processor 112 processes this information and returns other information as fields in a reply SCMP message.

A field in an SCMP message consists of the name of the field and a value. Thus, SCMP messages consist of a series of fields in name-value pairs, separated by newline characters. Two types of fields are recognized: order-level fields and offer-level fields.

When the issuance application 110 is working with function libraries of stored value certificate processor 112, then order level fields may be used within C/C++, Perl, or Java scripts. The issuance application 110 references the fields directly, specifying name-value pairs as described in later sections in this chapter. When the issuance application 110 is working with commerce-ready platforms, the merchant application uses an interface to specify field values, or where to find field values within a database or Web form.

### Certificate Processing Methods

Specific processing methods for online, electronic virtual certificates are now described. In this description, the term “certificate” refers broadly to a stored value certificate, gift certificate, promotions certificate, incentive certificate, reward or loyalty certificate, or award certificate. Further, the term “issuer” is used broadly to refer to the party that issues a certificate and receives and holds purchase funds or value for the certificate. An issuer may be a merchant, or an issuer may be a third party that hosts a site from which a purchaser may obtain certificates recognized by a plurality of merchants. In still another alternative, an issuer may be a third party that hosts a site or server that is private branded for a particular merchant, so that the site or server appears to be owned or operated by one particular merchant.

### Purchase Certificate Function

Generally, in purchase certificate function 222, a purchaser or gift giver can purchase an electronic virtual stored value certificate, sometimes called Internet Gift Certificates (“IGC”) by communicating with merchant server 108 A, 108B, 108N or, in an alternate embodiment, by connecting to third party issuer site 202 of stored value certificate processor 112. The purchaser specifies the amount of the certificate, the recipient's name and email address, the purchaser's name, payment type, payment information, and email information, and a message from the purchaser to the recipient. Other information can be collected. Purchasers can also specify when they want the notification sent. The certificate is created, loaded, and notification is sent at the appropriate time.

Promotion Certificates, Loyalty Certificates, and Incentive Certificates typically are mass issued by stored value certificate processor 112 based on input in the form of an electronic file prepared by the sponsoring merchant or company. The electronic file is received by stored value certificate processor 112 and processed according to the sponsor's instructions.

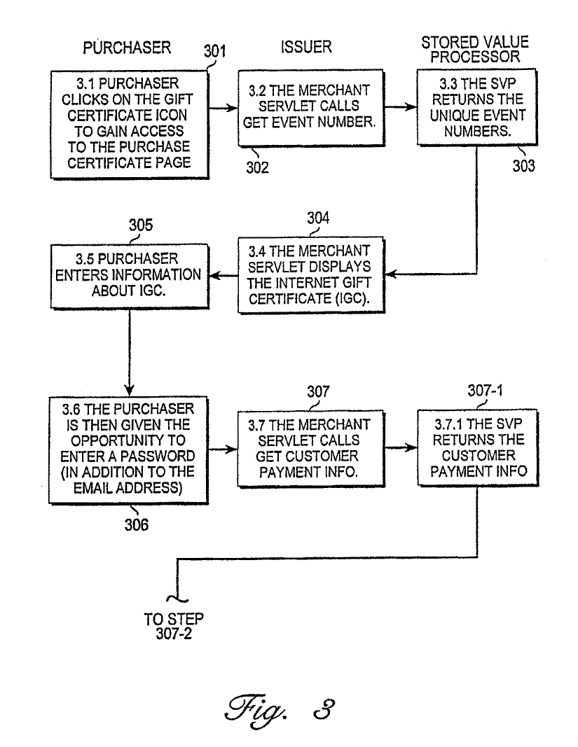

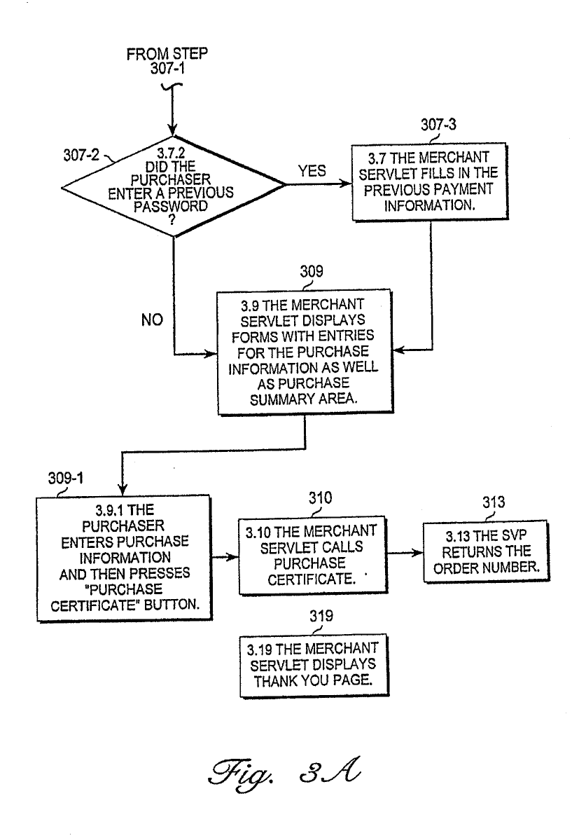

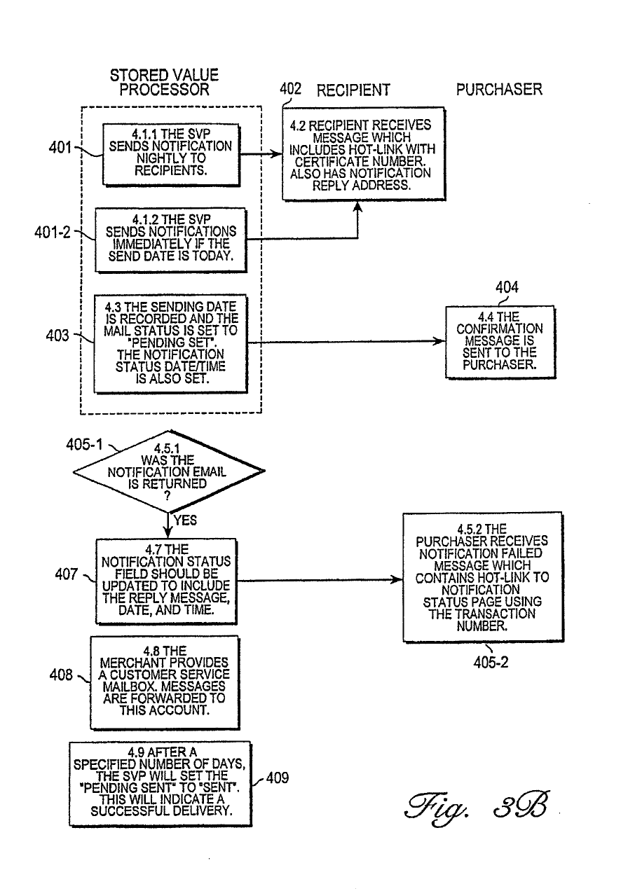

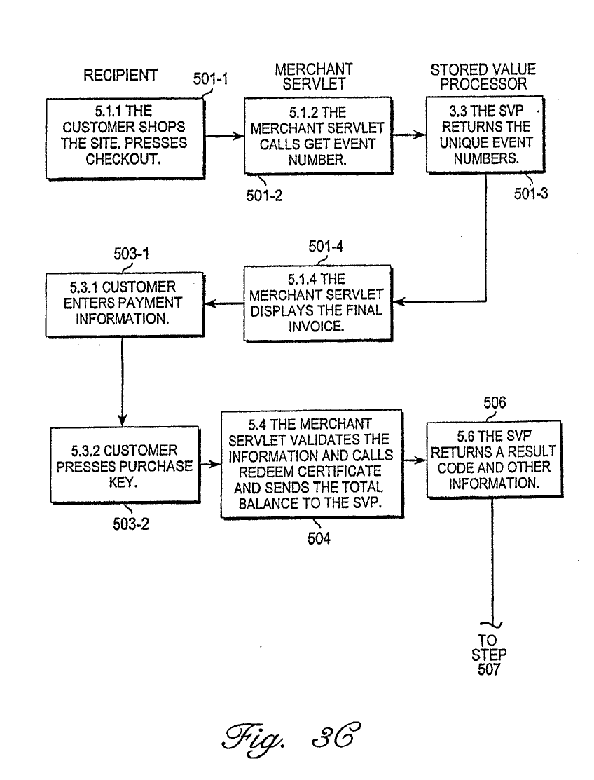

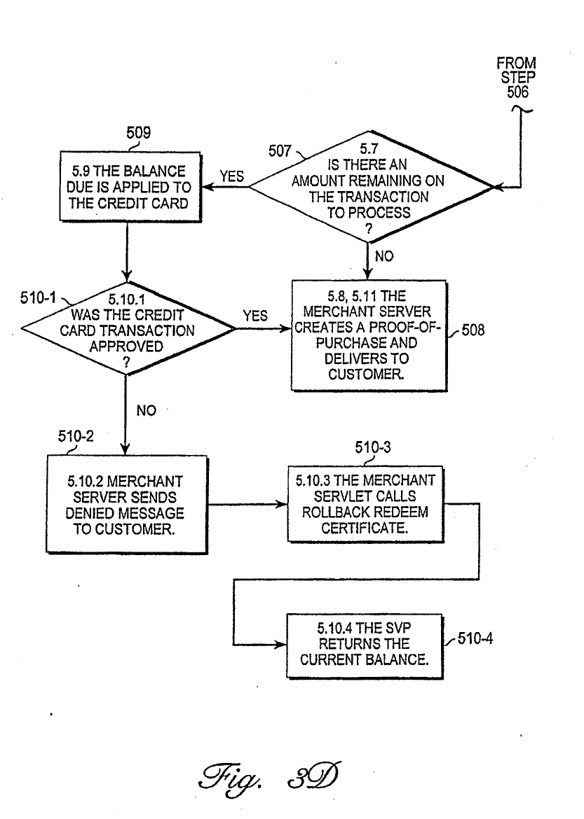

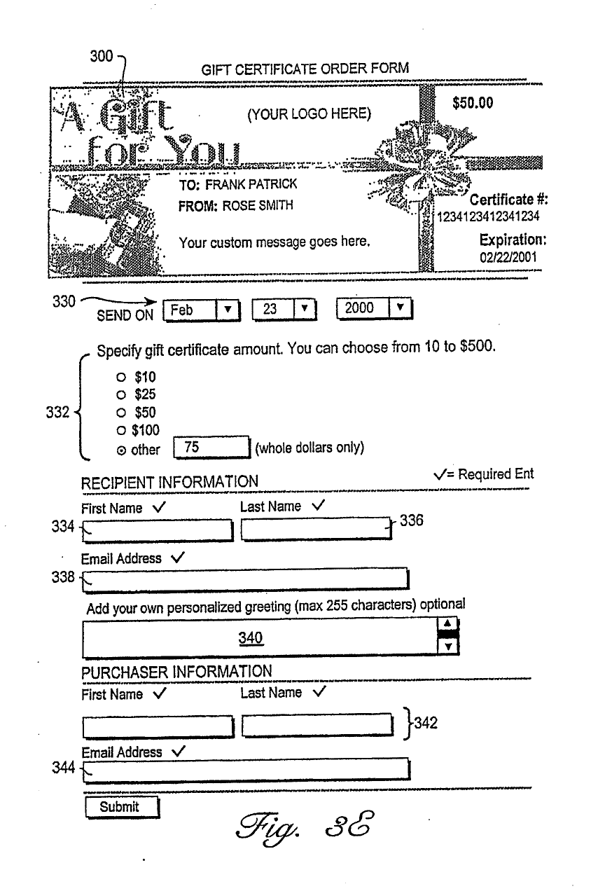

FIG. 3 is a flow diagram of a Purchase Certificate function. In block 301, a purchaser requests the purchase certificate function. In one embodiment, block 301 involves a purchaser clicking on a certificate icon of a Web site of an online merchant. In response, the merchant requests a unique identifier for a new certificate, as shown by block 302. In one embodiment, a servlet software element executed by merchant server 108 A, 108B, 108N calls purchase certificate function 222 of stored value certificate processor 112 using a network message that specifies a function in an application programming interface (API) of the stored value certificate processor.

In response, stored value certificate processor 112 returns a unique identifier value to the merchant, as shown by block 303. In one embodiment, a stored procedure executed by database 115 of the stored value certificate processor generates a unique order number or Event Number. The Event Number is sequentially generated, to ensure that the transaction is not duplicated in the event that the purchaser presses the Purchase Certificate key more than once due to slow network conditions.

At block 304, the merchant generates an image of a certificate and sends the image to a client, which displays it. FIG. 3E is a diagram of an example of a screen display that includes an image 300 of an electronic virtual stored value certificate as part of an order form. In a preferred embodiment, the image is configured with data entry fields that create the impression that the purchaser is filling out the certificate itself. The fields may be embedded within the graphic image. Mandatory data entry fields may be highlighted in color or with a message.

Examples of certificates include merchant or consumer gift certificates for an anniversary, holiday, birthday, or other gift occasion; loyalty program award certificates; employee reward certificates given for attaining specified goals; promotional certificates given by a merchant to recipients without purchase, for the purpose of inducing customer interest in the products or services of the merchant; etc. A merchant gift certificate is a certificate purchased at one merchant and redeemable only for goods or services of that merchant. A consumer gift certificate is a certificate purchased by a consumer from a third party funds holder, and that is redeemable at any merchant who accepts such certificates.

In block 305, a purchaser associated with the client system enters information about a certificate order. For example, a user of a client may enter data in fields of the order form shown in FIG. 3E. The information includes the name of the recipient, a network address of the recipient, such as an email address, and the initial face value of the certificate, i.e., the amount of the purchase by the purchaser.

In one embodiment, an order form of the type shown in FIG. 3E includes a send date field 330, amount radio buttons 332, recipient name fields 334, 336, recipient location identifier 338, message field 340, purchaser name fields 342, purchaser address field 344. The client or user may enter a date on which to send the certificate to the recipient in the send date field 330. For example, the purchaser may wish to send the certificate on a holiday, birthday, anniversary date, etc. The purchaser selects one of the amount radio buttons 332 to indicate the initial face value of the certificate.

Recipient name fields 334, 336 receive values identifying the name of the recipient of the certificate. Recipient location identifier 338 receives information that identifies where to send the certificate to the recipient. In the preferred embodiment, an email address of the recipient is provided. Message field 340 receives a greeting or other message from the purchaser to the receiver that will be delivered as part of the certificate. Purchaser name fields 342 identify the purchaser and are delivered as part of the certificate. Purchaser address field 344 identifies an address for use in sending confirmation and related information to the purchaser. Typically the purchaser address is an email address.

After entering appropriate information in each of the fields, in block 305, the purchaser is given the opportunity to enter a password to protect the information that has been entered for the certificate. In one embodiment, a Retrieve button is displayed in the order entry form. If the purchaser selects the Retrieve button, then the merchant determines whether the purchaser has already entered a password in a prior transaction. To make such a determination, in block 307, the merchant requests customer payment information for the current purchaser from the stored value certificate processor. In block 307-1, the stored value certificate processor returns any customer payment information in its database for the current purchaser to the merchant. FIG. 3A is a continuation of FIG. 3. In block 307-2, the merchant determines whether the purchaser previously entered a password. If so, then the merchant enters the password into a password field of the order form 300, as indicated by block 307-3.

If the purchaser has no information in the system, e.g., in database 115, then the purchaser is a new purchaser. Accordingly, the purchaser is prompted to enter identifying information such as an email address, password, purchaser's payment type and other payment information, name on the card, expiration date, purchaser's email information, purchaser and giver address, city, state, zip, and phone number.

Thereafter, the certificate is re-displayed, filled in with the purchase information as well as a purchase summary, as indicated in block 309. The purchase summary may include the certificate cost, a service fee if applicable, and the total purchase amount that is charged to the purchaser's credit card or other purchase mechanism. The total purchase amount field is calculated automatically. A Purchase Certificate button may be displayed. Required fields are validated on the form, before they are sent to the stored value certificate processor, to ensure that they contain valid values.

In block 309-1, the purchaser completes the purchase. In one embodiment, the purchaser enters purchase information using a client computer, and submits the purchase information and a purchase confirmation signal to the merchant. In response, in block 310, the merchant requests the stored value certificate processor to carry out a certificate purchase function. In one embodiment, the merchant servlet calls a purchase certificate function of the stored value certificate processor.

As indicated by block 313, the stored value certificate processor carries out the purchase function, and returns the order number associated with the certificate to the merchant. The purchase function may include validating the received data to ensure that all fields are filled out and contain appropriate data. In one embodiment, the amount value is tested to ensure that it is within the merchant's minimum and maximum amounts. The email addresses each must have both an “@” symbol and “.” symbol, in that order, separated by alphanumeric characters. The credit card number field must have only 15 or 16 numbers between “0” and “9”, a valid date value, and valid date to send value. The date to send value cannot specify a date in the past.

Payment gateway routines are called to authorize the payment transaction. The payment gateway routines comprise one or more software elements that are executed by the stored value certificate processor, by the merchant server or by a separate commerce server. The call to the payment gateway routines is the same kind of function call that is carried out by the merchant to authorize other product sales. For example, a credit card charge transaction is initiated.

The order number that is returned to the merchant may include an authorization or denial code that indicates whether the payment transaction succeeded or failed. If the payment transaction failed, then the merchant communicates a denial message to the purchaser.

If an authorization code is received, then a call is made from the merchant to the stored value certificate processor to create, load and activate the certificate. The call may include the certificate holder's name and email address, the purchaser's name, email address, activation date, short greeting message, merchant name, and merchant identifier as well as the redemption location code. The activation date is the then-current date, or the sending date of the notification, if different.

The stored value certificate processor creates and activates a certificate record in the certificate database, based on the information received in the call. Customer Number and Card Number fields each are assigned a unique identifier value. In a preferred embodiment, each identifier value comprises a 15-digit randomly generated number, and a checksum digit. A cancellation date value is also created and stored. The cancellation date value is the sum of the current date value, plus a pre-determined certificate life value. The certificate life value is created and stored in a merchant administration record that is uniquely associated in the database with a particular merchant. A typical certificate life value is one (1) year. Further, a Notification Sent flag is set to “N” or “NO.” The unique identifier value is also added to a notification utility data value for later use.

The stored value certificate processor loads the activated certificate with the designated initial face value (“stored value”) and generates a unique Order Number. The Order Number is the transaction number that is generated when the certificate is loaded. The stored value certificate processor then returns a Load transaction number to the merchant server. The Load transaction number can be used by the purchaser as a customer service reference number.

In block 319, if the charge transaction succeeded, the merchant servlet displays a confirmation or “thank you” page by communicating appropriate information to the client of the purchaser.

### Notification and Confirmation Functions

FIG. 3B is a flow diagram of Notification and Confirmation functions. Generally, Notification involves sending a message to the recipient on the appropriate date, indicating that the recipient has been given a certificate. The recipient notification may include a message describing the certificate, the name of the purchaser or giver, and a hyperlink with an embedded certificate number to view the actual certificate. A confirmation message is sent approximately at the same time to the purchaser to inform the purchaser that the notification has been sent. The confirmation message also states that the purchaser will receive a Notification Failed message if the confirmation message is undeliverable.

Referring now to FIG. 3B, in block 401, the stored value certificate processor sends a notification message to a recipient. In one embodiment, notifications are sent in a batch during a period of low network activity, e.g., at night. Notifications relating to certificates that have a send date of the current date may be sent immediately, as indicated by block 401-2.

In block 402, the recipient receives the notification message, which includes a hyperlink containing the certificate number. The notification message also includes a notification reply address. In block 403, the sending date of the notification message is stored in the database, and the status of the message for the certificate is set to “pending sent” in the database. A Notification Status Date/Time value is also set in the database to the date and time at which the notification message was sent.

In block 404, a Confirmation message is sent to the purchaser.

Referring now to block 405-1, at some future time, the stored value certificate processor determines whether the Notification message was returned as undeliverable. Block 405-1 may be carried out, for example, at a pre-determined time that is about one (1) to three (3) days later than the time than the Notification message is sent. If the Notification message was returned as undeliverable, then as shown in block 405-2, a Notification Failed message is sent to the purchaser. The Notification Failed message contains a hyperlink to a Notification Status page using the transaction number.

If the Notification message has not been returned as undeliverable, then in block 407, the Notification Status field of the database record for the certificate is updated to include the contents of the reply message, date and time. In block 408, the merchant provides the certificate processor with an address associated with a merchant customer service facility. For example, the merchant sends the certificate processor an email address of its merchant customer service mailbox. Subsequent messages are forwarded to that account. In block 409, after a specified number of days, the stored value certificate processor will set the value of the Notification Status field from “pending sent” to “sent.” This status change indicates a successful delivery.

### Redeem Certificate Function

FIG. 3C is a flow diagram of a Redeem Certificate function that enables single tender and split tender certificate redemption.

Generally, a certificate recipient is provided three (3) methods to redeem a certificate. First, the recipient may use its client and browser to connect directly to the stored value certificate processor and receive, in response, one or more electronic documents that include redemption links for various merchants. At that site, the recipient selects a link or logo of the merchant who issued the certificate.

Second, in a private branded method of operation, the recipient may use a client and browser to connect to stored value certificate processor 112, which displays one or more electronic documents that are associated with a particular merchant. For example, stored value certificate processor 112 supports a plurality of private-branded Web sites, each of which is associated with a different merchant. When the client connects to such a site, it appears to be the site of a merchant, even though it is hosted and operated by stored value certificate processor 112.

Third, the recipient may use its client and browser to select a link or logo of the merchant who issued the certificate at the merchant server 108 or any other server or site.

In one mode of operation, a certificate recipient (“customer”) shops a merchant site and adds products or services to a virtual shopping cart, as in any other product purchase transaction involving the merchant. If appropriate, the customer selects a shipping method for the products. A virtual invoice is displayed with a form to indicate the payment method and shipping information. The payment area includes a field for the recipient to enter the certificate number. Optionally, the recipient's messaging address (e.g., email address) is provided for verification purposes. A drop-down list may be provided in the virtual invoice for selecting a type of certificate from among several types offered by the merchant.

If the amount of the purchase is greater than the then-current stored value of the certificate, then the customer is prompted to enter a payment method and payment information, e.g., a credit card number. Following successful acceptance of the certificate as payment, the customer receives confirmation of the order and the remaining balance of the stored value of the certificate is displayed.

Referring now to FIG. 3C, in block 501-1, the recipient or customer shops a merchant site and selects a “checkout” option to request the merchant to compute an invoice for a purchase transaction. As a result, information identifying products or services selected by the customer is transferred to the merchant from the customer. In response, the merchant creates a virtual invoice of information for the transaction. In block 501-2, the merchant requests an event number from the stored value certificate processor.

In block 501-3, the stored value certificate processor returns a unique event number that is associated with and may be used for tracking the transaction. Generating an event number may be carried out using a stored procedure of database 115. The event number may be sequentially generated to ensure that the transaction is not duplicated if the purchaser presses the Redeem Certificate button more than once due to slow network conditions.

In block 501-4, the merchant displays the final invoice with pricing. The invoice may include data entry fields that receive further information from the customer, e.g., payment type, certificate number, and recipient address. Delivery information such as name, address and phone number may be received, based on the needs of the merchant. In block 503-1, the customer enters payment information. In block 503-2, the customer selects a Purchase button, or the equivalent, to confirm that the customer wishes to purchase the goods. In block 504, the merchant validates the order information, and calls a Redeem Certificate function of the stored value certificate processor. The function call includes the total balance of the order. In block 506, the stored value certificate processor returns a result code and related information.

Block 506 may involve the steps shown in connection with block 507 through block 510-4, inclusive, as shown in FIG. 3D. In one embodiment, as part of block 506, the stored value certificate processor responds by providing values for the amount of the purchase remaining after the stored value of the certificate is applied, the balance of stored value remaining on the certificate, a transaction number, and a result code. The result code may indicate an error, for example, if an invalid account number of recipient address is entered, if the certificate is inactive or expired.

In block 507, the stored value certificate processor determines whether, after applying the then-current stored value of the certificate, an amount due remains in the order. Block 507 also may involve evaluating the result code and taking appropriate action if an error has occurred. If there is a balance due, then in block 509, the balance due is collected using the payment method previously specified by the consumer. For example, if the consumer provided a credit card number, a charge transaction for the balance due is initiated. In block 510-1, a determination is made whether the balance has been collected successfully. If so, then control passes to block 508, in which the merchant creates a purchase confirmation message and delivers it to the customer. Control is also passed to block 508 if the test of block 507 is negative, that is, when there is no balance due for the order.

If the test of block 510-1 is negative, such that the balance cannot be collected using the payment method specified by the customer, then in block 510-2, the merchant sends a denial message to the customer. Further, in block 510-3, the merchant requests the stored value certificate processor to roll back the redemption transaction and restore the stored value of the certificate as it existed before the transaction started. In response, the stored value certificate processor carries out the rollback function, and returns the updated current stored value balance of the certificate to the merchant.

Thus, a split tender function increases revenue by allowing the consumer to purchase more than the stored value certificate amount and split the total sale between their certificate and other payment methods.

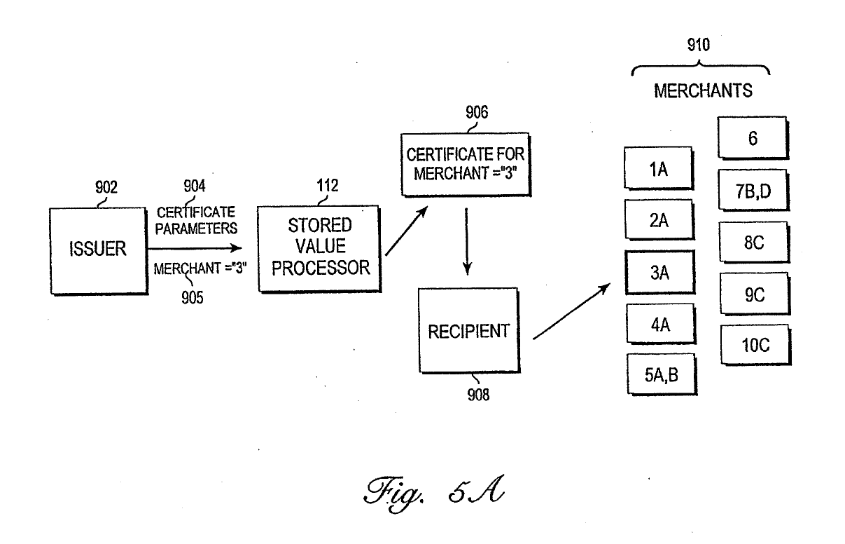

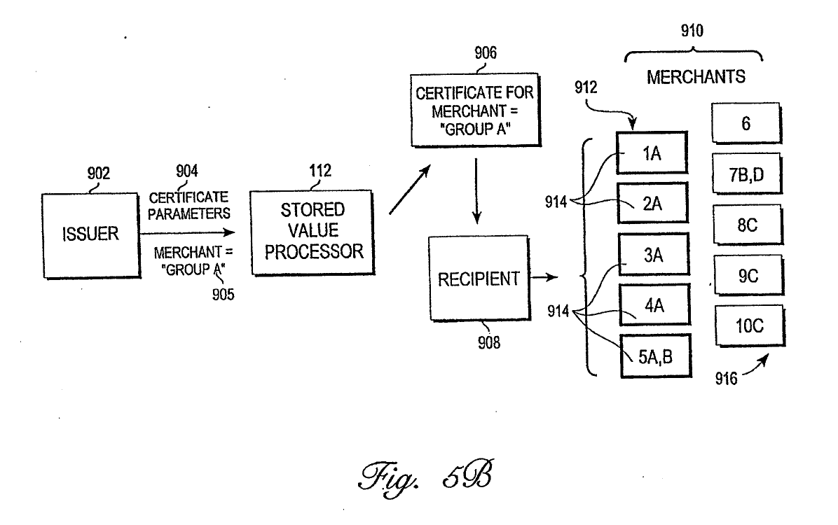

FIG. 5 A is a block diagram of a method of redeeming a stored value certificate that is redeemable only at one merchant or issuer.

Certificate Issuer 902 requests stored value certificate processor 112 to issue a certificate and passes certificate parameters to stored value certificate processor 112. The certificate parameters specifically identify the certificate. For example, certificate parameters include certificate value, recipient name and address, a message, etc.

Certificate parameters also include a merchant identifier 905 that is uniquely associated with one of a plurality of merchants 910. Each merchant has a unique merchant identifier, and a merchant group identifier. Merchant group identifiers associate one or more merchants in groups, all of which accept a particular certificate as tender for goods or services. In FIG. 5 A, each of the merchants 910 is identified with a symbol such as “1A,” “3A,” “9C”, etc. In each symbol, the numeric digit represents the merchant identifier and the alphabetic character represents the merchant group identifier.

In response to receiving the parameters, stored value certificate processor issues a certificate 906 and binds or associates the merchant identifier 905 to the certificate. For example, the merchant identifier is stored as a value in database 115. When recipient 908 wishes to redeem the certificate, only merchant 3A will recognize or accept the certificate 906 because merchant identifier “3” is associated only with merchant 3 A. Further, stored value certificate processor 112 will successfully carry out redemption functions only for certificates having merchant identifiers that match the associated merchant.

FIG. 5B is a block diagram of a method of redeeming a stored value certificate that is redeemable at a plurality of merchants or issuers.

As in FIG. 5A, certificate Issuer 902 requests stored value certificate processor 112 to issue a certificate and passes certificate parameters to stored value certificate processor 112. The certificate parameters specifically identify the certificate. For example, certificate parameters include certificate value, recipient name and address, a message, etc.

Certificate parameters also include a merchant group identifier 909 that is uniquely associated with a group of one or more among the plurality of merchants 910. For example, merchants 910 include a first group 912 (group “A”) that includes a plurality of merchants such as merchants 914, and other groups 916 that include other merchants.

In response to receiving the parameters, stored value certificate processor issues a certificate 906 and binds or associates the merchant group identifier 909 to the certificate. For example, the merchant identifier is stored as a value in database 115. When recipient 908 wishes to redeem the certificate, only merchants in the group associated with the merchant group identifier will recognize or accept the certificate 906. In the example of FIG. 5B, only merchants 914 will accept certificate 906 because merchant group identifier “A” is associated only with merchants 914. Further, stored value certificate processor 112 will successfully carry out redemption functions only for certificates having merchant group identifiers that match the associated merchant group.

In this way, the use of a certificate may be limited or expanded in a flexible manner. A certificate carries metadata that indicates where the certificate may be redeemed. Issuance of promotional certificates good at only one merchant, or non-specific certificates that are good at a variety of merchants, is facilitated.

### Certificate Administration Functions

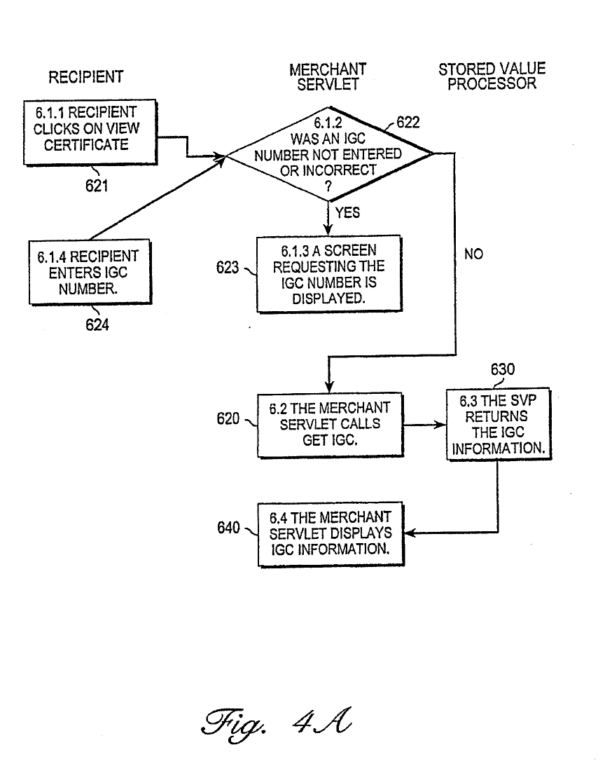

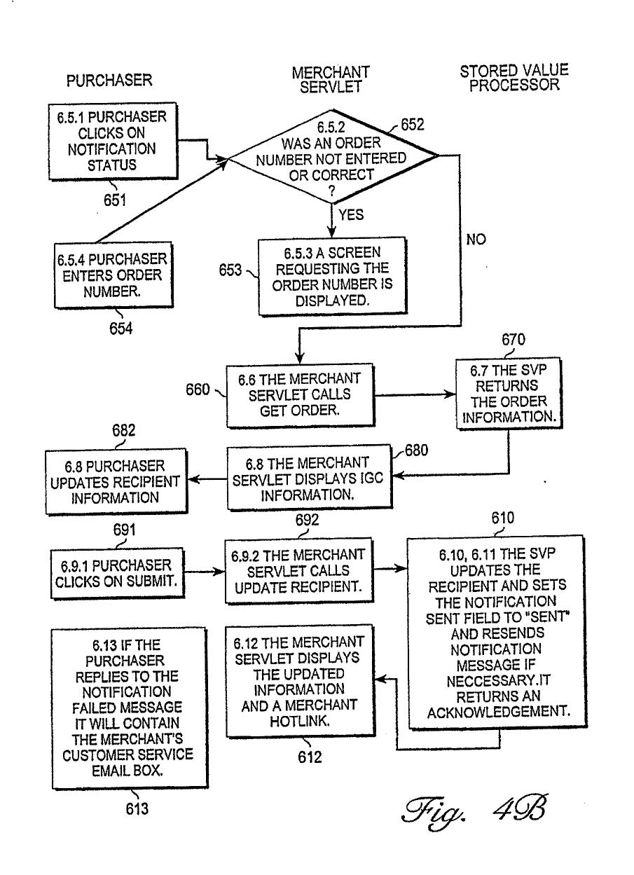

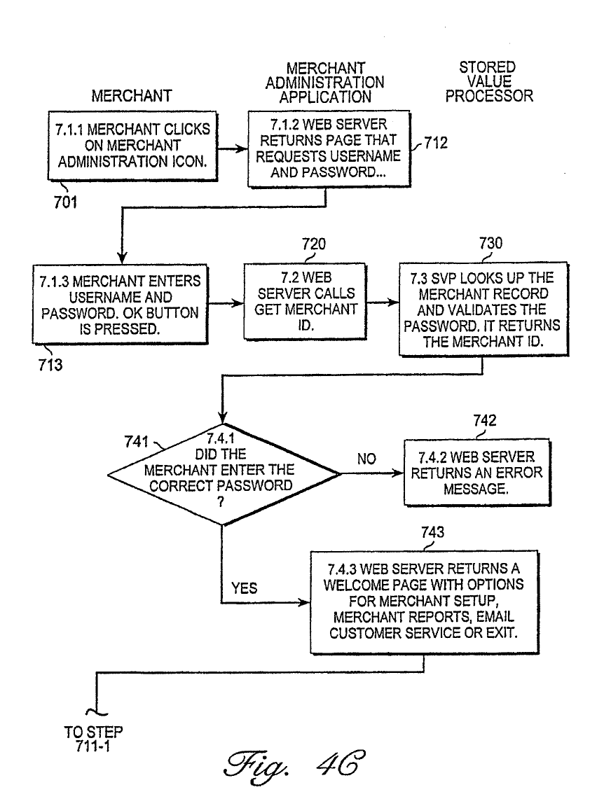

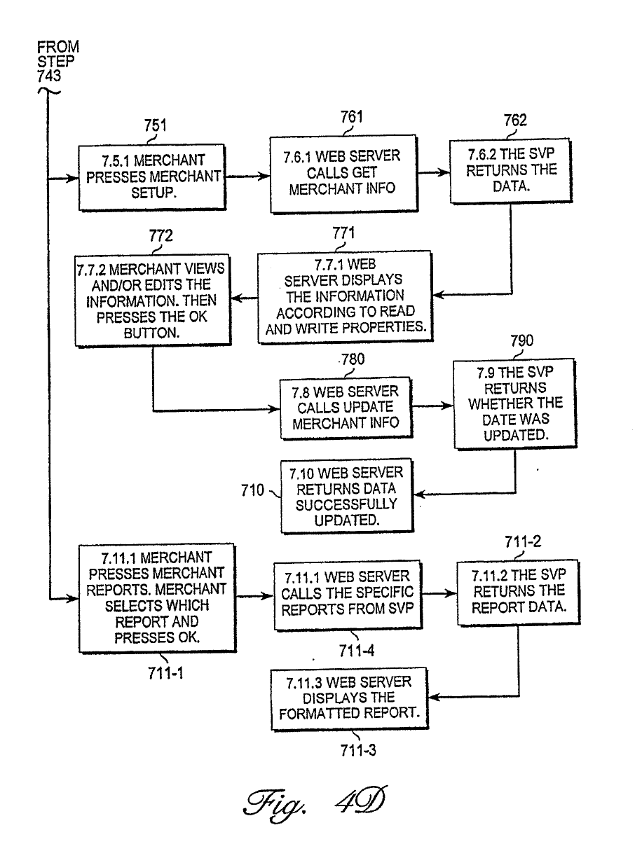

FIG. 4A is a flow diagram of a Certificate Administration (Recipient—View Certificate) function. Generally, a recipient may link to and view a certificate through a hyperlink in the Notification message that includes the certificate number (“hot link”), through a link at a server or site of the merchant, or through a link at stored value certificate processor 112 or another site or server of the certificate processor.

Referring now to FIG. 4A, in block 621, a recipient selects a View Certificate function. Block 621 may involve three methods. First, a recipient may select a hot link that includes a certificate number in a Notification message; second, the recipient may select a link at a merchant server or site; third, the recipient may select a link at a server or site associated with the stored value certificate processor.

In block 622, a determination is made whether a certificate number is not in the link or otherwise received from the recipient, or is incorrect. If any such condition exists, then in block 623, the merchant displays a data entry form or prompt that requests the recipient to enter a valid certificate number. Control passes to block 624, in which the recipient enters a certificate number, and thereafter, control passes to block 622 to re-check the certificate number.

When a valid certificate number has been received, then in block 620, the merchant requests certificate information for the certificate associated with the certificate number from the stored value certificate processor. The request may comprise a Java function call to the stored value certificate processor to retrieve a certificate record using the certificate number as the search key. The recipient email address also may be used as a secondary key to provide additional security.

In response, the stored value certificate processor attempts to retrieve certificate information from the database based on the certificate number. If the certificate number is valid, then the stored value certificate processor returns the certificate information, as shown by block 630. The returned certificate information may comprise the recipient name, purchaser name, message or greeting, stored value balance, expiration date, and transaction history.

In block 640, the merchant displays the certificate information. Block 640 may involve creating a formatted display that resembles a paper certificate and sending the display information to the client of the recipient.

FIG. 4B is a flow diagram of a Certificate Administration (Purchaser-Notification Status) function. Generally, the Purchaser-Notification Status function enables a certificate purchaser to check on the status of notification and delivery. It also allows changes to be made to the stored values for the recipient's email address, notification date, and message or greeting.

In block 651, the purchaser of a certificate selects the Notification Status function. Preferably, the Purchaser-Notification Status function may be accessed by linking from a Notification Failed message, which contains an embedded order number and purchaser address, or by linking from a merchant site. In block 652, the merchant server determines whether the function selection includes an order number. This may involve examining an HTTP request received from the client of the purchaser to determine whether an order number is included as a parameter.

If no order number is provided, or if the order number has an invalid format, then in block 653, the merchant generates a prompt or order form to the purchaser's client that requests the purchaser to enter a valid order number. In block 654, the purchaser enters an order number, and control is passed to block 652 to re-check the order number.

When a valid order number is received, in block 660, the merchant requests order information from the stored value certificate processor. Block 660 may involve making a function call to the stored value certificate processor using the order number as a primary key. The purchaser's email address also may be used as a secondary key as a further security measure.

In response, in block 670, the stored value certificate processor returns order information from the database to the merchant. The order information may comprise the recipient's name and email address, the purchaser's name and email address, a message or greeting, a certificate amount, a notification date, notification status information, a customer service address, and customer service telephone number. In block 680, the merchant creates display information for the certificate information and sends the display information to the client, which displays it. Block 680 may involve formatting the received information in a form that resembles a paper certificate, and displaying it as part of a Notification Status page.

In block 682, the purchaser enters updated recipient information using the client. However, if the value of the notification status information indicates that the certificate has been picked up or redeemed by the recipient, the recipient information cannot be updated. To update the information in the database, the purchaser selects a Submit button or the equivalent, as shown by block 691. In response, the merchant calls an Update Recipient function of the stored value certificate processor. This may involve calling a function of the stored value certificate processor that updates the recipient's address and the notification date value, if they have changed. The merchant also requests the stored value certificate processor to update the Notification Status field to “sent”, to appended to the date and time that the purchaser accessed the Notification Status page, and to add information indicating any actions taken by the purchaser.

In block 610, the stored value certificate processor updates the recipient information, and sets a value of a Notification Sent field to “sent.” A notification message is re-sent to the recipient, if necessary, e.g., when the purchaser changes the recipient's email address. If the sending date value for the certificate has been changed to the current date, then the stored value certificate processor queues the certificate for sending by storing the certificate number in a Notification Utility Data File. The stored value certificate processor also returns an acknowledgment message to the purchaser.

In block 612, the merchant displays the updated information. Block 612 may also involve sending an acknowledgment message from the stored value certificate processor to the merchant confirming that the notification status information has been updated.

### Merchant Administration Functions

FIG. 4C is a flow diagram of a Merchant Administration application that may be implemented in association with the stored value certificate processor. Generally, Merchant Administration is an application that can interact with a browser to store and retrieve merchant information. The Merchant Administration application is executed by a server that is logically separate from, but may be associated with, the stored value certificate processor. Alternatively, the Merchant Administration application may be co-located with or executed by the same server that acts as the stored value certificate processor. Merchant Administration allows merchants to view business parameter data as well as certificate sales and inventory reports. Preferably, the Merchant Administration application is available only to issuers and not to purchaser or recipients.

In block 701, a merchant selects the Merchant Administration function. In response, the Merchant Administration application provides a data entry form that accepts a user name and password, as shown by block 712. The merchant enters a user name and password and submits the values to the Merchant Administration application, as indicated by block 713. The merchant requests merchant information from the stored value certificate processor, as indicated by block 720. This may involve making a function call to the stored value certificate processor to authenticate or validate the user name and password. In block 730, the stored value certificate processor looks up a merchant record in the database, validates the password, and returns a merchant identifier. In one embodiment, the stored value certificate processor loads a merchant parameter record from a merchant table of the database, and validates the password.

In block 741, a determination is made whether the merchant entered a correct password. If not, in block 742, the Merchant Administration application returns an error message to the client of the merchant. If validation is successful, then in block 743 the Merchant Administration application returns an initial page (“Welcome page”) that presents functional options for Merchant Setup, Merchant Reports, Customer Service, Exit, etc.

FIG. 4D is a continuation of FIG. 4C. In block 751, a Merchant Setup function is selected. The Merchant Setup function is used to enter or change basic business parameters relating to the merchant. In response, the stored value certificate processor retrieves the data based on the merchant number. It validates the password and responds with the data. For example, as shown in block 761, the Merchant Administration application uses a function call to the stored value certificate processor to retrieve a merchant parameter record from database 115 using the merchant identifier and password as keys. In block 762, the stored value certificate processor returns the data to the Merchant Administration application.

In response, the merchant server displays the data according to the read and modify properties that are assigned to each field, as shown by block 771. The merchant identifier is private to the system and is not displayed. Fields available to the merchant to modify are displayed. The merchant views or makes changes to the information, as indicated in block 772, and presses a Submit button or OK button to transfer the changes to the Merchant Administration application.

In block 780, the Merchant Administration application updates the merchant information. For example, if changes are made to any modifiable field, then a function call is made to the stored value certificate processor to update the business parameter record. Before making the call, fields are validated for appropriate data. In block 790, the stored value certificate processor further validates the information and stores the updated record in the merchant parameter file. It responds back to the merchant server when the update is complete, as shown by block 710. The merchant server may notify the client that the data has been successfully updated.

In block 711-1, the merchant selects a report function. Block 711-1 may involve displaying a list of available reports at the merchant's client computer. The merchant selects a desired report from the list. In response, the Merchant Administration application calls the stored value certificate processor and requests the desired report using a report code associated with the report, as indicated by block 711-4. The report code may be generated from a third party report package that allows the stored value certificate processor to add and modify merchant reports.

In block 711-2, the stored value certificate processor returns the report data to the Merchant Administration application. In block 711-3, the Merchant Administration application displays the formatted report.

### Overview of Hardware Useful in an Implementation

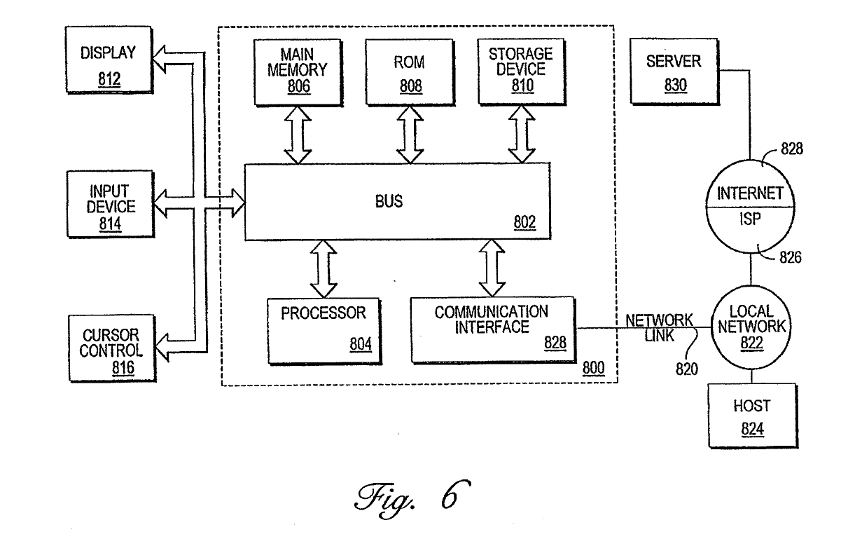

FIG. 6 is a block diagram that illustrates a computer system 800 upon which an embodiment of the invention may be implemented.

Computer system 800 includes a bus 802 or other communication mechanism for communicating information, and a processor 804 coupled with bus 802 for processing information. Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

The invention is related to the use of computer system 800 for automatically verifying address information. According to one embodiment of the invention, automatically verifying address information is provided by computer system 800 in response to processor 804 executing one or more sequences of one or more instructions contained in main memory 806. Such instructions may be read into main memory 806 from another computer-readable medium, such as storage device 810. Execution of the sequences of instructions contained in main memory 806 causes processor 804 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 804 for execution. Such a medium may take many forms, including but not limited to, non-volatile media, volatile media, and transmission media. Non-volatile media includes, for example, optical or magnetic disks, such as storage device 810. Volatile media includes dynamic memory, such as main memory 806. Transmission media includes coaxial cables, copper wire and fiber optics, including the wires that comprise bus 802. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 804 for execution. For example, the instructions may initially be carried on a magnetic disk of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are exemplary forms of carrier waves transporting the information.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818. In accordance with the invention, one such downloaded application provides for automatically verifying address information as described herein.

The received code may be executed by processor 804 as it is received, and/or stored in storage device 810, or other non-volatile storage for later execution. In this manner, computer system 800 may obtain application code in the form of a carrier wave.

### Scope of Disclosure

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

A system or process configured in the foregoing manner offers numerous advantages over the prior art. For example, such a system or process may result in increasing first-time buyers at a particular online merchant site, converting shoppers to buyers, and increasing sales. The certificate processor is invisible to the consumer, stored value certificate purchaser and recipient, and handles all details of certificate issuance, redemption, statements, and transaction processing. A split tender function increases revenue of a merchant by allowing the consumer to purchase more than the stored value certificate amount and split the total sale between their certificate and other payment methods.

Although such advantages are important, a system or process that falls within the scope of the appended claims is within the scope of the contemplated invention, regardless of whether such system or process actually achieves the advantages stated herein. Thus, the advantages should be considered as exemplary of one embodiment and not a requirement of conformance to the claims.

| Name Of Field | Used In Function | Type | Format | Database Min Length | Database Max Length | |
|---|---|---|---|---|---|---|
| | AddValue | float | decimal number | | | |
| | AddValue | varchar | string | 16 characters | 16 | characters |
| | AddValue | varchar | string | 1 character | 50 | characters |
| Result | AddValue | integer | integer | | | |
| Result | ChangeGiftSVC | integer | integer | 16 characters | 16 | characters |
| CertificateNumber | ChangeGiftSVC | varchar | string | | | |
| | ChangeGiftSVC | date | M/D/YYYY | | | |
| | CommitRedeemSVC | float | decimal number | | | |
| | CommitRedeemSVC | varchar | string | 1 character | 50 | characters |
| Result | CommitRedeemSVC | integer | integer | | | |
| | CommitRedeemSVC | integer | integer | | | |
| TransactionList | GetCertificateTransactions | varchar | string | 1 character | 50 | characters |
| Result | GetCertificateTransactions | integer | integer | | | |
| Result | GetCustFee | float | decimal number | | | |
| | GetCustFee | integer | integer | | | |
| | GetCustFee | varchar | string | 1 character | 50 | characters |
| | GetCustFee | integer | integer | | | |
| GiftProfileList | GetGiftProfiles | varchar | URLEncodedList | | | |
| Result | GetGiftProfiles | integer | integer | | | |
| MerchantList | GetMerchantGroupList | varchar | URLEncodedList | | | |
| Result | GetMerchantGroupList | integer | integer | | | |
| | GetNewSVCId | varchar | string | 1 character | 50 | characters |
| StoreId | GetNewSVCId | integer | integer | | | |
| Result | GetPurchaserInfo | integer | integer | | | |
| PurchaserFName | GetPurchaserInfo | varchar | string | 1 character | 50 | characters |
| PurchaserMName | GetPurchaserInfo | varchar | string | 1 character | 50 | characters |
| PurchaserLName | GetPurchaserInfo | varchar | string | 1 character | 50 | characters |
| PurchaserEmail | GetPurchaserInfo | varchar | string | 1 character | 255 | characters |
| PurchaserPassword | GetPurchaserInfo | varchar | string | 1 character | 50 | characters |
| PurchaserPasswordHint | GetPurchaserInfo | varchar | string | 1 character | 255 | characters |
| PurchaserTitle | GetPurchaserInfo | varchar | string | 1 character | 10 | characters |
| PurchaserSuffix | GetPurchaserInfo | varchar | string | 1 character | 10 | characters |
| PurchaserAddress1 | GetPurchaserInfo | varchar | string | 1 character | 50 | characters |
| PurchaserAddress2 | GetPurchaserInfo | varchar | string | 1 character | 50 | characters |
| PurchaserCity | GetPurchaserInfo | varchar | string | 1 character | 50 | characters |
| PurchaserState | GetPurchaserInfo | varchar | string | 1 character | 2 | characters |
| PurchaserZip | GetPurchaserInfo | varchar | string | 1 character | 5 | characters |
| PurchaserHomePhone | GetPurchaserInfo | varchar | string | 1 character | 10 | characters |
| PurchaserCCNumber | GetPurchaserInfo | varchar | string | 1 character | 16 | characters |
| PurchaserCCExpirationDate | GetPurchaserInfo | varchar | string | 1 character | 9 | characters |
| PurchaserCCNameOnCard | GetPurchaserInfo | varchar | string | 1 character | 30 | characters |
| PuchaserHint | GetPurchaserPasswordHint | varchar | string | 1 character | 255 | characters |
| Result | GetPurchaserPasswordHint | integer | integer | | | |
| CertificateHTML | GetSVCHTML | varchar | HTML | | | |
| TransactionsHTML | GetSVCHTML | varchar | HTML | | | |
| | GetSVCHTML | varchar | string | 1 character | 255 | characters |
| Result | GetSVCHTML | integer | integer | | | |
| Result | GetSVCIdFromOrderNumber | integer | integer | | | |
| SVCId | GetSVCIdFromOrderNumber | integer | integer | | | |
| Result | GetSVCInfo | integer | integer | | | |
| PurchaserId | GetSVCInfo | integer | integer | | | |
| SVCBatchId | GetSVCInfo | integer | integer | | | |
| CreatedDateTime | GetSVCInfo | datetime | m/d/yyyy h:m:s | | | |
| LoadAmount | GetSVCInfo | float | decimal number | | | |
| BalanceAmount | GetSVCInfo | float | decimal number | | | |
| RecipientId | GetSVCInfo | integer | integer | | | |
| Message | GetSVCInfo | varchar | string | | | |
| IsActive | GetSVCInfo | boolean | string | 1 character | 1 | character |
| ActivationDateTime | GetSVCInfo | datetime | m/d/yyyy h:m:s | | | |
| CancellationDateTime | GetSVCInfo | datetime | m/d/yyyy h:m:s | | | |
| OrderNumber | GetSVCInfo | varchar | string | | | |
| NotificationStatus | GetSVCInfo | varchar | string | | | |
| FullName | GetSVCInfo | varchar | string | | | |
| SVCType | GetSVCInfo | varchar | string | | | |
| StoreId | GetSVCInfo | integer | integer | | | |
| CertificateProfile | GetSVCInfo | integer | integer | | | |
| TemplateIdString | GetSVCInfo | varchar | string | | | |
| RecipientEmailAddress | GetSVCInfo | varchar | string | | | |
| PurchaserEmailAddress | GetSVCInfo | varchar | string | | | |
| RecipientFirstName | GetSVCInfo | varchar | string | | | |
| RecipientMiddleName | GetSVCInfo | varchar | string | | | |
| RecipientLastName | GetSVCInfo | varchar | string | | | |
| PurchaserFirstName | GetSVCInfo | varchar | string | | | |
| PurchaserMiddleName | GetSVCInfo | varchar | string | | | |
| PurchaserLastName | GetSVCInfo | varchar | string | | | |
| PurchaserAddress1 | GetSVCInfo | varchar | string | | | |
| PurchaserAddress2 | GetSVCInfo | varchar | string | | | |
| PurchaserCity | GetSVCInfo | varchar | string | | | |
| PurchaserState | GetSVCInfo | varchar | string | | | |
| PurchaserPostalCode | GetSVCInfo | varchar | string | | | |
| PurchaserPhoneNumber | GetSVCInfo | varchar | string | | | |
| EmailCorrect | GetSVCInfoFromOrderNumber | | | | | |
| Result | GetSVCInfoFromOrderNumber | | | | | |
| PurchaserId | GetSVCInfoFromOrderNumber | | | | | |
| SVCBatchId | GetSVCInfoFromOrderNumber | | | | | |
| CreatedDateTime | GetSVCInfoFromOrderNumber | | | | | |
| LoadAmount | GetSVCInfoFromOrderNumber | | | | | |
| BalanceAmount | GetSVCInfoFromOrderNumber | | | | | |
| RecipientId | GetSVCInfoFromOrderNumber | | | | | |
| Message | GetSVCInfoFromOrderNumber | | | | | |
| IsActive | GetSVCInfoFromOrderNumber | | | | | |
| ActivationDateTime | GetSVCInfoFromOrderNumber | | | | | |
| CancellationDateTime | GetSVCInfoFromOrderNumber | | | | | |
| OrderNumber | GetSVCInfoFromOrderNumber | | | | | |
| NotificationStatus | GetSVCInfoFromOrderNumber | | | | | |
| FullName | GetSVCInfoFromOrderNumber | | | | | |
| SVCType | GetSVCInfoFromOrderNumber | | | | | |
| StoreId | GetSVCInfoFromOrderNumber | | | | | |
| SVCId | GetSVCInfoFromOrderNumber | | | | | |
| RecipientEmailAddress | GetSVCInfoFromOrderNumber | | | | | |
| PurchaserEmailAddress | GetSVCInfoFromOrderNumber | | | | | |
| RecipientFirstName | GetSVCInfoFromOrderNumber | | | | | |
| RecipientMiddleName | GetSVCInfoFromOrderNumber | | | | | |
| RecipientLastName | GetSVCInfoFromOrderNumber | | | | | |
| RecipientTitle | GetSVCInfoFromOrderNumber | | | | | |
| RecipientSuffix | GetSVCInfoFromOrderNumber | | | | | |
| RecipientAddress1 | GetSVCInfoFromOrderNumber | | | | | |
| RecipientAddress2 | GetSVCInfoFromOrderNumber | | | | | |
| RecipientCity | GetSVCInfoFromOrderNumber | | | | | |
| RecipientState | GetSVCInfoFromOrderNumber | | | | | |
| RecipientPostalCode | GetSVCInfoFromOrderNumber | | | | | |
| RecipientPhoneNumber | GetSVCInfoFromOrderNumber | | | | | |
| PurchaserFirstName | GetSVCInfoFromOrderNumber | | | | | |
| PurchaserMiddleName | GetSVCInfoFromOrderNumber | | | | | |
| PurchaserLastName | GetSVCInfoFromOrderNumber | | | | | |
| PurchaserTitle | GetSVCInfoFromOrderNumber | | | | | |
| PurchaserSuffix | GetSVCInfoFromOrderNumber | | | | | |
| PurchaserAddress1 | GetSVCInfoFromOrderNumber | | | | | |
| PurchaserAddress2 | GetSVCInfoFromOrderNumber | | | | | |
| PurchaserCity | GetSVCInfoFromOrderNumber | | | | | |
| PurchaserState | GetSVCInfoFromOrderNumber | | | | | |
| PurchaserPostalCode | GetSVCInfoFromOrderNumber | | | | | |
| PurchaserPhoneNumber | GetSVCInfoFromOrderNumber | | | | | |
| CertificateNumber | GetSVCInfoFromOrderNumber | | | | | |
| Result | GetSVCInfoFromCertificateNumber | | | | | |
| EmailCorrect | GetSVCInfoFromCertificateNumber | | | | | |
| PurchaserId | GetSVCInfoFromCertificateNumber | | | | | |
| SVCBatchId | GetSVCInfoFromCertificateNumber | | | | | |
| CreatedDateTime | GetSVCInfoFromCertificateNumber | | | | | |
| LoadAmount | GetSVCInfoFromCertificateNumber | | | | | |
| BalanceAmount | GetSVCInfoFromCertificateNumber | | | | | |
| RecipientId | GetSVCInfoFromCertificateNumber | | | | | |
| Message | GetSVCInfoFromCertificateNumber | | | | | |
| IsActive | GetSVCInfoFromCertificateNumber | | | | | |
| ActivationDateTime | GetSVCInfoFromCertificateNumber | | | | | |
| CancellationDateTime | GetSVCInfoFromCertificateNumber | | | | | |
| OrderNumber | GetSVCInfoFromCertificateNumber | | | | | |
| NotificationStatus | GetSVCInfoFromCertificateNumber | | | | | |
| FullName | GetSVCInfoFromCertificateNumber | | | | | |
| SVCType | GetSVCInfoFromCertificateNumber | | | | | |
| StoreId | GetSVCInfoFromCertificateNumber | | | | | |
| SVCId | GetSVCInfoFromCertificateNumber | | | | | |
| ProfileId | GetSVCInfoFromCertificateNumber | | | | | |
| RecipientEmailAddress | GetSVCInfoFromCertificateNumber | | | | | |
| PurchaserEmailAddress | GetSVCInfoFromCertificateNumber | | | | | |
| RecipientFirstName | GetSVCInfoFromCertificateNumber | | | | | |
| RecipientMiddleName | GetSVCInfoFromCertificateNumber | | | | | |
| RecipientLastName | GetSVCInfoFromCertificateNumber | | | | | |
| RecipientTitle | GetSVCInfoFromCertificateNumber | | | | | |
| RecipientSuffix | GetSVCInfoFromCertificateNumber | | | | | |
| RecipientAddress1 | GetSVCInfoFromCertificateNumber | | | | | |
| RecipientAddress2 | GetSVCInfoFromCertificateNumber | | | | | |
| RecipientCity | GetSVCInfoFromCertificateNumber | | | | | |
| RecipientState | GetSVCInfoFromCertificateNumber | | | | | |
| RecipientPostalCode | GetSVCInfoFromCertificateNumber | | | | | |
| RecipientPhoneNumber | GetSVCInfoFromCertificateNumber | | | | | |
| PurchaserFirstName | GetSVCInfoFromCertificateNumber | | | | | |
| PurchaserMiddleName | GetSVCInfoFromCertificateNumber | | | | | |
| PurchaserLastName | GetSVCInfoFromCertificateNumber | | | | | |
| PurchaserTitle | GetSVCInfoFromCertificateNumber | | | | | |
| PurchaserSuffix | GetSVCInfoFromCertificateNumber | | | | | |
| PurchaserAddress1 | GetSVCInfoFromCertificateNumber | | | | | |
| PurchaserAddress2 | GetSVCInfoFromCertificateNumber | | | | | |
| PurchaserCity | GetSVCInfoFromCertificateNumber | | | | | |
| PurchaserState | GetSVCInfoFromCertificateNumber | | | | | |
| PurchaserPostalCode | GetSVCInfoFromCertificateNumber | | | | | |
| PurchaserPhoneNumber | GetSVCInfoFromCertificateNumber | | | | | |
| Result | InitiateConnection | | | | | |
| Result | LoadGiftSVC | | | | | |
| OrderNumber | LoadGiftSVC | | | | | |
| PurchaserId | LoadGiftSVC | | | | | |
| CreatedDate | LoadGiftSVC | | | | | |
| RecipientId | LoadGiftSVC | | | | | |
| IsActive | LoadGiftSVC | | | | | |
| CancellationDate | LoadGiftSVC | | | | | |
| NotificationStatus | LoadGiftSVC | | | | | |
| SVCType | LoadGiftSVC | | | | | |
| BalanceAmount | LoadGiftSVC | | | | | |
| CertificateNumber | LoadGiftSVC | | | | | |
| SVCId | LoadGiftSVC | | | | | |
| CertificateHTML | PreviewCertificateHTML | | | | | |
| Result | PreviewCertificateHTML | | | | | |
| AmountRedeemed | RedeemSVC | | | | | |
| SVCTranId | RedeemSVC | | | | | |
| Result | RedeemSVC | | | | | |
| Result | RollbackRedeemSVC | | | | | |
| Result | TestConnection | | | | | |
| HTML | TestConnection | | | | | |
| Result | VerifyLogin | integer | integer | | | |
| Result | ViewCertificate | integer | integer | | | |
| SVCBatchId | ViewCertificate | | | | | |
| CreatedDateTime | ViewCertificate | | | | | |
| LoadAmount | ViewCertificate | | | | | |
| BalalanceAmount | ViewCertificate | | | | | |
| Message | ViewCertificate | | | | | |
| IsActive | ViewCertificate | | | | | |
| CancellationDate | ViewCertificate | | | | | |
| ActivationDate | ViewCertificate | | | | | |
| OrderNumber | ViewCertificate | | | | | |
| NotificationStatus | ViewCertificate | | | | | |
| SvcType | ViewCertificate | | | | | |
| CertificateNumber | ViewCertificate | | | | | |
| MinPurchaseAmount | ViewCertificate | | | | | |
| StoreId | ViewCertificate | | | | | |
| TestMode | ViewCertificate | | | | | |
| SVCStyleId | ViewCertificate | | | | | |
| ShippingMethod | ViewCertificate | | | | | |
| Shipper | ViewCertificate | | | | | |
| IsPhysical | ViewCertificate | | | | | |
| RecipientEmail | ViewCertificate | | | | | |
| RecipientAddress1 | ViewCertificate | | | | | |
| RecipientAddress2 | ViewCertificate | | | | | |
| RecipientFirstName | ViewCertificate | | | | | |
| RecipientMiddleName | ViewCertificate | | | | | |
| RecipientLastName | ViewCertificate | | | | | |
| City | ViewCertificate | | | | | |
| State | ViewCertificate | | | | | |
| Zip | ViewCertificate | | | | | |
| ZipPlusFour | ViewCertificate | | | | | |
| HomePhone | ViewCertificate | | | | | |

* Case is perserved in the database for all fields. However, there are separate case insensitive lookup fields for the email addresses and customer names.
Unless specified, all allowable Characters for all calls are ASCII characters.
In order to pass a value to the SVP the field must have minimum length of 1 character. Those fields are nullable in the database. (Min. length 0).

1. A method, comprising:
receiving, using one or more processors, data corresponding to a virtual value account, wherein the data includes customer data, initial value data, and one or more unique merchant identifiers or unique merchant group identifiers;
receiving, using the one or more processors, a request to generate the virtual value account;
generating, using the one or more processors, the virtual value account, wherein generating includes binding the one or more unique merchant identifiers or the one or more unique merchant group identifiers to the virtual value account such that only merchants associated with one of the unique merchant identifiers will recognize the virtual value account, and wherein only merchants in groups associated with one of the merchant group identifiers will recognize the virtual value account;
activating, using the one or more processors, the virtual value account, wherein activating includes associating the virtual value account with a unique account identifier, a unique customer identifier corresponding to the customer data, and an account value corresponding to the initial value data;
receiving, using the one or more processors, a transaction associated with a merchant, wherein the transaction includes a unique account identifier, a unique customer identifier, and a unique merchant identifier or unique merchant group identifier;
determining, using the one or more processors, whether the unique account identifier and the unique customer identifier associated with the virtual value account matches the unique account identifier and the unique customer identifier associated with the transaction;
determining, using the one or more processors, whether a unique merchant identifier or a unique merchant group identifier corresponding to the virtual value account matches the unique merchant identifier or the unique merchant group identifier associated with the transaction; and
processing, using the one or more processors, the transaction when the unique account identifiers, the unique customer identifiers, and the unique merchant identifiers or the unique merchant group identifiers match, wherein processing includes updating the account value.

2. The method of claim 1, wherein the virtual value account is a merchant gift certificate redeemable only for goods or services from an issuing merchant.

3. The method of claim 1, wherein the virtual value account is a consumer gift certificate purchased from a third party, and wherein the consumer gift certificate is redeemable at any merchant.

4. The method of claim 1, wherein the virtual value account is a consumer gift certificate purchased from a third party, and wherein the consumer gift certificate is redeemable only for goods or services from an issuing merchant.

5. The method of claim 1, wherein the virtual value account is a loyalty program award certificate.

6. The method of claim 5, wherein the loyalty program is a universal loyalty program, and wherein the universal loyalty program allows frequent shopper point redemption among multiple merchants.

7. The method of claim 5, wherein the loyalty program award certificate limits frequent shopper point redemption to an issuing merchant.

8. The method of claim 5, wherein the loyalty program award certificate represents a pre-determined fraction of each transaction.

9. The method of claim 1, wherein the customer is an employee, and wherein the virtual value account is an employee reward certificate awarded for attaining a specific goal.

10. The method of claim 1, wherein the virtual value account is a promotional certificate.

11. The method of claim 1, further comprising:
transmitting, using the one or more processors, one or more notifications or confirmations corresponding to the virtual value account.

12. The method of claim 1, further comprising:
re-instating, using the one or more processors, the account value associated with the virtual value account, wherein the re-instated account value is the original account value.

13. The method of claim 1, further comprising:
re-instating, using the one or more processors, the account value associated with the virtual value account, wherein the re-instated account value is the account value prior to the last update.

14. The method of claim 1, further comprising:
indicating, using the one or more processors, that a balance is due when the account value is less than a value associated with the transaction.

15. The method of claim 1, wherein the updated account value becomes a new account value for subsequent transactions until the updated account value is zero.

16. The method of claim 1, wherein the updated account value becomes a new account value for subsequent transactions when the account value remains positive.

17. A system, comprising:
one or more processors;
a non-transitory computer-readable storage medium containing instructions configured to cause the one or more processors to perform operations, including:
receiving data corresponding to a virtual value account, wherein the data includes customer data, initial value data, and one or more unique merchant identifiers or unique merchant group identifiers;
receiving a request to generate the virtual value account;
generating the virtual value account, wherein generating includes binding the one or more unique merchant identifiers or the one or more unique merchant group identifiers to the virtual value account such that only merchants associated with one of the unique merchant identifiers will recognize the virtual value account, and wherein only merchants in groups associated with one of the merchant group identifiers will recognize the virtual value account;
activating the virtual value account, wherein activating includes associating the virtual value account with a unique account identifier, a unique customer identifier corresponding to the customer data, and an account value corresponding to the initial value data;
receiving a transaction associated with a merchant, wherein the transaction includes a unique account identifier, a unique customer identifier, and a unique merchant identifier or unique merchant group identifier;
determining whether the unique account identifier and the unique customer identifier associated with the virtual value account matches the unique account identifier and the unique customer identifier associated with the transaction;
determining whether a unique merchant identifier or a unique merchant group identifier corresponding to the virtual value account matches the unique merchant identifier or the unique merchant group identifier associated with the transaction; and
processing the transaction when the unique account identifiers, the unique customer identifiers, and the unique merchant identifiers or the unique merchant group identifiers match, wherein processing includes updating the account value.

18. The system of claim 17, wherein the virtual value account is a merchant gift certificate redeemable only for goods or services from an issuing merchant.

19. The system of claim 17, wherein the virtual value account is a consumer gift certificate purchased from a third party, and wherein the consumer gift certificate is redeemable at any merchant.

20. The system of claim 17, wherein the virtual value account is a consumer gift certificate purchased from a third party, and wherein the consumer gift certificate is redeemable only for goods or services from an issuing merchant.

21. The system of claim 17, wherein the virtual value account is a loyalty program award certificate.

22. The system of claim 21, wherein the loyalty program is a universal loyalty program, and wherein the universal loyalty program allows frequent shopper point redemption among multiple merchants.

23. The system of claim 21, wherein the loyalty program award certificate limits frequent shopper point redemption to an issuing merchant.

24. The system of claim 21, wherein the loyalty program award certificate represents a pre-determined fraction of each transaction.

25. The system of claim 17, wherein the customer is an employee, and wherein the virtual value account is an employee reward certificate awarded for attaining a specific goal.

26. The system of claim 17, wherein the virtual value account is a promotional certificate.

27. The system of claim 17, further comprising instructions to cause the one or more processors to perform operations, including:
transmitting one or more notifications or confirmations corresponding to the virtual value account.

28. The system of claim 17, further comprising instructions to cause the one or more processors to perform operations, including:
re-instating the account value associated with the virtual value account, wherein the re-instated account value is the original account value.

29. The system of claim 17, further comprising instructions to cause the one or more processors to perform operations, including:
re-instating the account value associated with the virtual value account, wherein the re-instated account value is the account value prior to the last update.

30. The system of claim 17, further comprising instructions to cause the one or more processors to perform operations, including:
indicating that a balance is due when the account value is less than a value associated with the transaction.

31. The system of claim 17, wherein the updated account value becomes a new account value for subsequent transactions until the updated account value is zero.

32. The system of claim 17, wherein the updated account value becomes a new account value for subsequent transactions when the account value remains positive.

33. A computer program product, tangibly embodied in a non-transitory machine readable storage medium, including instructions configured to cause a data processing apparatus to:
receive data corresponding to a virtual value account, wherein the data includes customer data, initial value data, and one or more unique merchant identifiers or unique merchant group identifiers;
receive a request to generate the virtual value account;
generate the virtual value account, wherein generating includes binding the one or more unique merchant identifiers or the one or more unique merchant group identifiers to the virtual value account such that only merchants associated with one of the unique merchant identifiers will recognize the virtual value account, and wherein only merchants in groups associated with one of the merchant group identifiers will recognize the virtual value account;
activate the virtual value account, wherein activating includes associating the virtual value account with a unique account identifier, a unique customer identifier corresponding to the customer data, and an account value corresponding to the initial value data;
receive a transaction associated with a merchant, wherein the transaction includes a unique account identifier, a unique customer identifier, and a unique merchant identifier or unique merchant group identifier;
determine whether the unique account identifier and the unique customer identifier associated with the virtual value account matches the unique account identifier and the unique customer identifier associated with the transaction;
determine whether a unique merchant identifier or a unique merchant group identifier corresponding to the virtual value account matches the unique merchant identifier or the unique merchant group identifier associated with the transaction; and
process the transaction when the unique account identifiers, the unique customer identifiers, and the unique merchant identifiers or the unique merchant group identifiers match, wherein processing includes updating the account value.

34. The computer program product of claim 23, wherein the virtual value account is a merchant gift certificate redeemable only for goods or services from an issuing merchant.

35. The computer program product of claim 23, wherein the virtual value account is a consumer gift certificate purchased from a third party, and wherein the consumer gift certificate is redeemable at any merchant.

36. The computer program product of claim 23, wherein the virtual value account is a consumer gift certificate purchased from a third party, and wherein the consumer gift certificate is redeemable only for goods or services from an issuing merchant.

37. The computer program product of claim 23, wherein the virtual value account is a loyalty program award certificate.

38. The computer program product of claim 24, wherein the loyalty program is a universal loyalty program, and wherein the universal loyalty program allows frequent shopper point redemption among multiple merchants.

39. The computer program product of claim 24, wherein the loyalty program award certificate limits frequent shopper point redemption to an issuing merchant.

40. The computer program product of claim 24, wherein the loyalty program award certificate represents a pre-determined fraction of each transaction.

41. The computer program product of claim 23, wherein the customer is an employee, and wherein the virtual value account is an employee reward certificate awarded for attaining a specific goal.

42. The computer program product of claim 23, wherein the virtual value account is a promotional certificate.

43. The computer program product of claim 23, further comprising instructions configured to cause a data processing apparatus to:
transmit one or more notifications or confirmations corresponding to the virtual value account.

44. The computer program product of claim 23, further comprising instructions configured to cause a data processing apparatus to:
re-instate the account value associated with the virtual value account, wherein the re-instated account value is the original account value.

45. The computer program product of claim 23, further comprising instructions configured to cause a data processing apparatus to:
re-instate the account value associated with the virtual value account, wherein the re-instated account value is the account value prior to the last update.

46. The computer program product of claim 23, further comprising instructions configured to cause a data processing apparatus to:
indicate that a balance is due when the account value is less than a value associated with the transaction.

47. The computer program product of claim 23, wherein the updated account value becomes a new account value for subsequent transactions until the updated account value is zero.

48. The computer program product of claim 23, wherein the updated account value becomes a new account value for subsequent transactions when the account value remains positive.
